(19) United States
(12) Patent Application Publication
(10) Pub. No.: US 2024/0273360 A1
(43) Pub. Date: Aug. 15, 2024

(54) SYSTEMS AND METHODS FOR TRAINING, SECURING, AND IMPLEMENTING AN ARTIFICIAL NEURAL NETWORK

(71) Applicant: KONINKLIJKE PHILIPS N.V., EINDHOVEN (NL)

(72) Inventors: Ramil GIZATULLIN, EINDHOVEN (NL); Andrey POLYAKOV, EINDHOVEN (NL)

(21) Appl. No.: 18/560,950

(22) PCT Filed: May 16, 2022
(86) PCT No.: PCT/EP2022/063169

§ 371 Date: Nov. 15, 2023

(30) Foreign Application Priority Data
May 21, 2021 (RU) 2021114493

(51) Int. Cl. G06N 3/08; H04L 9/08

(52) U.S. Cl. CPC G06N 3/08; H04L 9/088

(57) ABSTRACT

A non-transitory computer readable medium (26) stores instructions readable and executable by at least one electronic processor (20) to perform a method (200) of performing an analysis on digital information (15) to be analyzed. The method includes receiving a cryptographic key (16): constructing an input dataset, the input dataset including both the digital information to be analyzed and the cryptographic key: performing the analysis on the digital information to be analyzed to generate an analysis result (32) by applying an artificial neural network (ANN) (12) to the input dataset: and outputting the analysis result.

### FIELD

The following relates generally to the medical arts, artificial intelligence (AI) arts, artificial neural network (ANN) arts, medical image analysis arts, computer-aided diagnosis (CADx) arts, and related arts.

### BACKGROUND

Artificial intelligence (AI) is known for use in medical applications. For example, a convolutional neural network (CNN) can be trained to receive a medical image and output whether a particular finding is present, i.e., to perform computer-aided diagnosis (CADx), or to output other information such as identification of problematic image artifacts. More generally, multilayer artificial neural networks (ANNs), also sometimes referred to as Deep Neural Networks (DNNs), are trained to perform various functions in medical devices. Also referred to herein as multilayer neural networks (NNs), they are widely used for diverse tasks, both in the medical field and elsewhere.

In many ANN model implementations, to solve a particular problem (e.g., to perform a specific CADx task), the parameters of an ANN architecture are trained. These parameters may include, for example, weights and parameters of convolutional or dense layers of the neural connections, which are optimized by training on a large body of (typically annotated) training data. For the CADx example, the training data may be a collection of training medical images which are annotated by human domain experts (e.g., radiologists) as to whether the particular finding for which the CADx model is to be trained is present.

The resulting ANN model can be a valuable item of intellectual property, which the model vendor would like to protect. However, the nature of ANN implementation makes this difficult. In many cases, the ANN architecture is a licensed commercial software product, or is implemented using open-source software, or is a published ANN architecture. Hence, the ANN architecture itself may not the property of the model vendor. Rather, the vendor's intellectual property is embodied by the set of trained parameters of the trained ANN model. Unfortunately, this information is difficult to protect if the ANN model is to be distributed to customers, such as hospitals. While the trained parameters set can be supplied to customers as an encrypted file, that file typically must be decrypted at the customer end in order to be used in conjunction with the ANN architecture. Once decrypted, the parameters set is easily compromised.

Some solutions have been developed, notably fully homomorphic encryption, which can enable secure distribution of the parameters set by enabling the encrypted parameters to be used directly. The homomorphic-encrypted trained parameters can be directly used, without first decrypting them. However, homomorphic encryption severely degrades the speed of the ANN model, and moreover the homeomorphic-encrypted trained parameters may still be illicitly shared and used. Another approach is to add a digital watermark to the parameters set (sometimes referred to as a digital passport). While this can facilitate detection of unauthorized use of the ANN model, it cannot prevent such infringement.

The following discloses certain improvements to overcome these problems and others.

### SUMMARY

In some embodiments disclosed herein, a non-transitory computer readable medium stores instructions readable and executable by at least one electronic processor to perform a method of performing an analysis on digital information to be analyzed. The method includes receiving a cryptographic key; constructing an input dataset, the input dataset including both the digital information to be analyzed and the cryptographic key; performing the analysis on the digital information to be analyzed to generate an analysis result by applying an ANN to the input dataset; and outputting the analysis result.

In some embodiments disclosed herein, a method of simultaneously training and securing an ANN includes generating a trained ANN for performing an analysis, including: performing a plurality of valid-key training cycles on the ANN with datasets, each dataset including digital information to be analyzed and a valid cryptographic key, wherein the valid-key training cycles employ an analysis objective function that drives the valid-key training cycles to produce a correct analysis result for the digital information to be analyzed, and performing a plurality of invalid-key training cycles on the ANN with datasets, each dataset including digital information to be analyzed and an invalid cryptographic key, wherein the invalid-key training cycles employ a security objective function that drives the invalid-key training cycles to produce an incorrect analysis result for the digital information to be analyzed; and storing the trained ANN on a non-transitory storage medium.

One advantage resides in increasing security of an ANN without significant concomitant degradation in the speed of the ANN.

Another advantage resides in facilitating distribution of a trained ANN while still enabling the underlying intellectual property to be secure.

Another advantage resides in using a secure ANN to analyze medical images.

Another advantage resides in using a secure ANN to perform CADx analyses.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the disclosure.

FIG. 1 diagrammatically illustrates an apparatus for securely training, distributing, and deploying an ANN in accordance with the present disclosure.

FIG. 2 diagrammatically illustrates methods for securely training, distributing, and deploying an ANN using the apparatus of FIG. 1.

FIG. 3 shows an example of a secure ANN constructed using the apparatus of FIG. 1.

### DETAILED DESCRIPTION

The following discloses an approach for securing an ANN model. The approach augments the input to the ANN model with an encryption key (which may be logically organized as a single key or as a set of keys). The model is trained on two objectives: first, to produce an accurate output for given operative data input (e.g., an accurate determination of whether the input image contains the finding) when the correct cryptographic key is provided; and second, to produce a random output for given operative data input when an incorrect cryptographic key is provided. In this way, the cryptographic key is embedded into the ANN model itself.

During training, the first objective is suitably implemented as a loss minimization using the valid cryptographic key, and the second objective is suitably implemented as a loss maximization when using randomly or pseudorandomly generated cryptographic keys. in experiments that most iterations of the training should use the correct cryptographic key, and a smaller number of iterations should use randomly or pseudorandomly generated incorrect cryptographic keys. Additionally, the first iterations preferably use only the correct cryptographic key to initially establish the ANN model. In the experiments, a first 50,000 iterations used the correct key, and thereafter about 10% of the iterations used incorrect keys, although these are merely non-limiting examples.

With the ANN model trained with the embedded cryptographic key, the model vendor provides the parameter set to the customer, along with software implementing the ANN architecture if it is not already available to the customer (e.g., as a standard library ANN). Separately, the correct cryptographic key is provided to the customer, either directly from the vendor or via a trusted third party. Because the distributed ANN model was trained with the (correct) cryptographic key and was trained to produce random results with other (incorrect) keys, the ANN model will only work correctly if the customer inputs the correct cryptographic key when using the model.

One possible concern with this approach can arise in the medical context. If the customer uses the ANN model with an incorrect cryptographic key, then the ANN model will produce incorrect (i.e., random) results. This could occur if the customer uses the cryptographic key of an older version of the ANN model, or if the customer receives an unauthorized copy of the ANN model. This situation could result in degraded medical care of the patient. One way to address this is to instruct the customer to validate the ANN model before clinical use by applying it to a set of images for which the correct output is known. Another possible approach is to train the ANN model to provide a further output that indicates whether the cryptographic key is correct, and to issue an alert if that output indicates an incorrect cryptographic key is being used.

The illustrative implementation described herein employs a CNN-based model, the input is an image, and the cryptographic key is a binary mask. More generally, the ANN model could employ any multilayer ANN and the cryptographic key could be a single key or a set of multiple keys, and each key may be a vector, two-dimensional (2D) array, three-dimensional (3D) array, or other data structure. The cryptographic key should have a sufficient number of bits to ensure the encryption cannot be feasibly broken by brute force techniques.

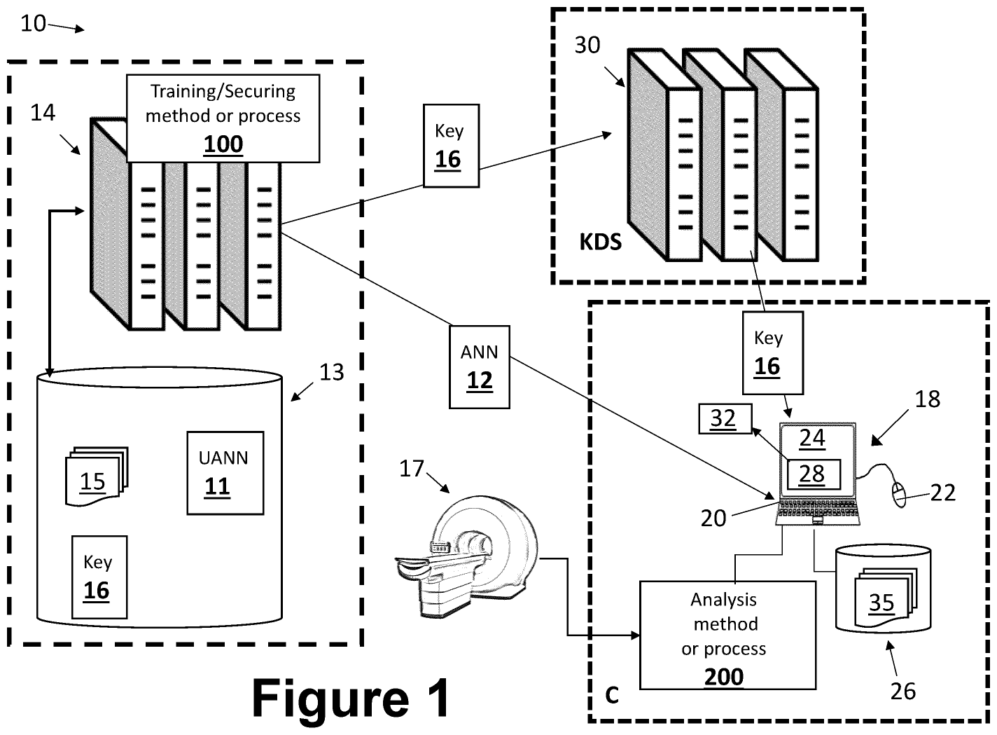

With reference to FIG. 1, an illustrative apparatus 10 for training and securing a Neural Network (NN), specifically an Artificial Neural network (ANN) 12. For example, the ANN 12 can comprise a multi-layer ANN. In some embodiments, the ANN 12 can be a convolutional NN (CNN), or any other suitable ANN. The apparatus 10 is implemented on an electronic processor 14, such as a server computer or illustrative multiple server computers 14 (e.g., a server cluster or farm, a cloud computing resource, or so forth), which implements a method or process 100 of simultaneously training and securing the ANN 12. To perform the method 100, the electronic processor 20 accesses at least one non-transitory storage medium 13 that stores the ANN architecture 11 (that is, the “untrained” ANN, and labeled in FIG. 1 as “UANN”), along with training data comprising digital information 15 which is to be analyzed (e.g., medical images, CADx diagnosis data, and so forth). The training data 15 are preferably annotated as to the expected (i.e. ground truth) value that the ANN is to be trained to generate. For example, if the ANN is being trained to implement a CADx, the training data 15 may be clinical images, with each training clinical image labeled (i.e. annotated) as to whether the diagnosis is shown by that training clinical image. This is merely an example.

As another illustrative example, the ANN 12 may be trained to analyze log data of a medical imaging device 17, such as an illustrative magnetic resonance imaging (MRI) scanner, a positron emission tomography (PET) scanner, a computed tomography (CT) scanner, or so forth. Complex medical imaging devices such as MRI, PET, CT, and so forth are computerized and generate extensive log data recording imaging device configuration, imaging sessions performed using the imaging device, output of various sensors, alarms, and so forth. In some commercial settings, these data are recorded as log files that are occasionally uploaded to the imaging device vendor or other contracted device maintenance service provider. In these types of applications, the ANN 12 may for example be trained to proactively identify expected component failure times for key components such as the X-ray tube of a CT scanner to facilitate performing timely preventative maintenance. In such applications, the training data 15 may be historical log data from medical imaging devices annotated with relevant information such as actual component failure times.

The non-transitory storage medium 13 is also configured to store a cryptographic key 16 that will be used in training the UANN 11 as described herein to produce a trained ANN 12 that will only produce correct analysis results for an input that includes the (valid) cryptographic key 16. The cryptographic key 16 can comprise, for example, a binary mask, a vector, a two-dimensional array, or a three-dimensional array, or any other suitable key. The cryptographic key 16 may be logically organized as a single key, or as a set of (multiple) keys that collectively form the cryptographic key 16. The cryptographic key 16 is used in the training of the UANN 11 to produce the trained ANN 12 that is only usable with the valid cryptographic key 16, as described herein.

The at least one electronic processor 14 is configured as described above to perform the method 100. The non-transitory storage medium 13 stores instructions which are readable and executable by the at least one electronic processor 14 to perform disclosed operations including performing the method or process 100. In some examples, the method 100 may be performed at least in part by cloud processing.

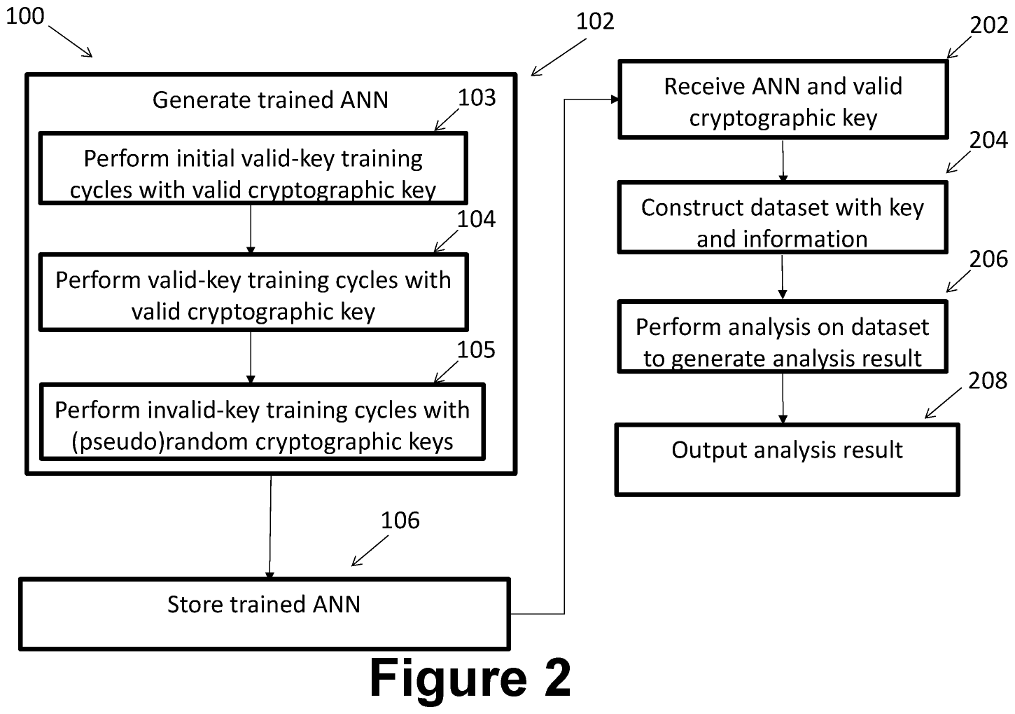

With reference to FIG. 2, and with continuing reference to FIG. 1, an illustrative embodiment of the method 100 is diagrammatically shown as a flowchart. At an operation 102, a trained ANN 12 is generated for performing an analysis. To do so, at a sub-operation 104, a plurality of valid-key training cycles is performed on the ANN with training data drawn from the digital training information 15. The input datasets used in the training cycles of sub-operation 104 are referred to herein as valid-key input datasets, and include the (valid) cryptographic key 16. More particularly, each valid-key input dataset includes the cryptographic key 16, and the entire valid-key input dataset including the cryptographic key 16 serves as the input to the ANN undergoing training. The valid-key training cycles of sub-operation 104 employ an analysis objective function that drives the valid-key training cycles to produce a correct analysis result for the digital information 15 to be analyzed. As used here, a correct analysis result is an output of the ANN that matches the “ground truth” label annotated to the input training data. For example, if the ANN is being trained to implement a CADx function for detecting finding X, then the training images are annotated as to whether they exhibit finding X, and a correct analysis result for an input training image is an output of the ANN that matches the annotated indication of the presence or absence of finding X for that training image. The analysis objective function in some non-limiting illustrative embodiments comprises CE(logitsK,labels), where the function CE( . . . ) is a cross-entropy loss, logitsK are the outputs of the valid-key training cycles generated by the ANN, and labels is the set of ground truth labels annotated to the training datasets (e.g., annotated by a domain expert). The sub-operation 104 is used to train the ANN to generate a correct analysis result for the digital information to be analyzed if the input dataset includes the (valid) cryptographic key 16.

At a sub-operation 105, another plurality of training cycles, referred to herein as invalid-key training cycles, is performed on the ANN undergoing training. In this sub-operation 105, the datasets include the digital information 15 to be analyzed and randomly or pseudorandomly generated cryptographic keys. More particularly, each invalid-key input dataset includes a randomly or pseudorandomly generated cryptographic key, and the entire invalid-key input dataset including the randomly or pseudorandomly generated cryptographic key serves as the input to the ANN undergoing training. The invalid-key training cycles employ a different objective function, referred to as a security objective function, that drives the invalid-key training cycles to produce an incorrect analysis result (e.g. a random or pseudorandom result) for the digital information 15 to be analyzed. The security objective function in some non-limiting illustrative embodiments comprises |10−CE(logitsR,labels)| where the logitsR are the outputs of the invalid-key training cycles. The sub-operation 105 is used to train the ANN to generate an incorrect (e.g., random or pseudorandom) analysis result for the digital information to be analyzed if an invalid cryptographic key is input as part of the dataset. The invalid keys can be generated using a random or pseudorandom number generator, and should have the same data structure as the (valid) cryptographic key 16. As an aside, while referred to as invalid keys, it may be possible, although extremely unlikely, that any particular randomly or pseudorandomly generated “invalid” key might by chance match the valid cryptographic key 16—however, such an extremely unlikely event, even if it occurs, will have negligible impact on the training of sub-operation 105 so long as the number of invalid-key training cycles is sufficiently large.

A number of the plurality of valid-key training cycles performed during the sub-operation 104 is in some non-limiting embodiments higher than a number of the plurality of invalid-key training cycles performed during the sub-operation 105. This is advantageous because it typically takes more cycles to train the ANN to correctly analyze the input data with the valid cryptographic key 16 than to train the ANN to produce an incorrect (e.g., random or pseudorandom) result with an incorrect key. In some examples, the number of the plurality of valid-key training cycles is at least 5 times greater than the number of the plurality of invalid-key training cycles. In other examples, the number of training cycles with the invalid (e.g., random or pseudorandom) cryptographic key comprises 9%-11% of the number of training cycles with the valid cryptographic key 16.

It should be noted that the valid-key training cycles of operation 104 and the invalid-key training cycles of operation 105 can be interleaved, e.g. if 10% of the total training cycles are to use invalid (e.g. random or pseudorandom) keys then these can be interleaved amongst the other 90% of cycles that use the valid cryptographic key 16. As a further optional variant, prior to the sub-operations 104 and 105, an optional sub-operation 103 can be performed, in which a predetermined number of initial valid-key training cycles are performed with datasets in which each dataset includes the digital information 15 to be analyzed and the valid cryptographic key 16 and employing the analysis objective function. This provides for the ANN to be initially strongly trained to produce correct analysis results with the valid cryptographic key 16.

At an operation 106, the trained ANN 12 is stored on the non-transitory storage medium 13.

Referring back to FIG. 1, a key distribution service (denoted as KDS) is shown and is in communication with a customer C and the vendor. In a typical setting, the customer C orders a copy of the trained ANN 12 from the vendor for a medical use (e.g., image analysis, CADx diagnoses, component failure prediction for a medical imaging device 17, and so forth). This order may be for the ANN by itself, or the ANN may be included in a larger order, e.g. an order for a medical imaging device 17 may include the ANN for analyzing images generated by that imaging device, generating key component failure time estimates by analyzing log files generated by the medical imaging device 17 to facilitate proactive maintenance of the key components, or so forth. When the order is placed, the vendor sends the trained ANN 12 to the customer C, and separately sends the valid cryptographic key 16 to the key distribution center KDS. The customer then receives the valid cryptographic key 16 from the key distribution center KDS.

The customer C includes or has access to an electronic processing device 18, such as a workstation computer, or more generally a computer. The electronic processing device 18 may also include a server computer or a plurality of server computers, e.g., interconnected to form a server cluster, cloud computing resource, or so forth, to perform more complex computational tasks. The electronic processing device 18 is configured to apply the trained ANN 12 with the valid cryptographic key 16 to perform a medical analysis. The workstation 18 includes typical components, such as an electronic processor 20 (e.g., a microprocessor), at least one user input device (e.g., a mouse, a keyboard, a trackball, and/or the like) 22, and a display device 24 (e.g., an LCD display, plasma display, cathode ray tube display, and/or so forth). In some embodiments, the display device 24 can be a separate component from the workstation 18, or may include two or more display devices.

The electronic processor 20 is operatively connected with one or more non-transitory storage media 26. The non-transitory storage media 26 may, by way of non-limiting illustrative example, include one or more of a magnetic disk, RAID, or other magnetic storage medium; a solid-state drive, flash drive, electronically erasable read-only memory (EEROM) or other electronic memory; an optical disk or other optical storage; various combinations thereof; or so forth; and may be for example a network storage, an internal hard drive of the workstation 18, various combinations thereof, or so forth. It is to be understood that any reference to a non-transitory medium or media 26 herein is to be broadly construed as encompassing a single medium or multiple media of the same or different types. Likewise, the electronic processor 20 may be embodied as a single electronic processor or as two or more electronic processors. The non-transitory storage media 26 stores instructions executable by the at least one electronic processor 20. The instructions include instructions to generate a visualization of a graphical user interface (GUI) 28 for display on the display device 24.

In addition, the key distribution service KDS also includes or has access to an electronic processor 30, such as a server computer or illustrative multiple server computers 30 (e.g., a server cluster or farm, a cloud computing resource, or so forth) for storage of the digital information 15 to be analyzed and the valid cryptographic key 16.

The at least one electronic processor 20 is configured as described above to perform a method or process 200 of performing an analysis on digital information 35 to be analyzed. The digital information 35 is of the same type and format as the digital information 15 used to train the ANN. For example, if the trained ANN is a CADx that determines whether a computed tomography (CT) image shows a particular finding, then the training data 15 are training CT images each annotated with a label indicating whether the finding is present; and the digital information 35 is in this case also a CT image (but here not annotated, as the trained ANN is being used as the CADx to make the finding determination). If the ANN is trained to perform predictive component failure analysis for medical imaging devices, then the digital information 35 to be analyzed may be log files of the medical imaging device 17. The non-transitory storage medium 26 stores instructions which are readable and executable by the at least one electronic processor 20 to perform disclosed operations including performing the method or process 200. In some examples, the method 200 may be performed at least in part by cloud processing.

Referring again to FIG. 2, and with continuing reference to FIG. 1, an illustrative embodiment of the method 200 is diagrammatically shown as a flowchart. To begin the method 200, the customer C places the order for the trained ANN 12 from the vendor. The vendor then transmits the cryptographic key 16 to the key distribution service KDS, and the trained ANN 12 to the customer C.

At an operation 202, the cryptographic key 16 (i.e., the valid cryptographic key) is received by the electronic processing device 18 from the key distribution center KDS. The digital information 35 to be analyzed is combined with the cryptographic key 16 received from the key distribution center KDS (or in some variant embodiments, the cryptographic key 16 can be received by the customer C directly from the vendor; or viewed another way in these variant embodiments the vendor also serves as the key distribution center).

At an operation 204, an input dataset is constructed that includes the digital information 35 to be analyzed, along with the cryptographic key 16 received from the key distribution center KDS.

At an operation 206, an analysis is performed on the dataset generated at operation 204 including the digital information 35 to be analyzed and the valid cryptographic key 16 to generate an analysis result 32. To do so, the ANN 12 is applied to the input dataset constructed at the operation 204. Since the valid cryptographic key 16 is used, the trained ANN 12 has been trained by way of the valid-key training cycles 103, 104 to produce a correct result (e.g., the illustrative CADx correctly determines whether the CT image shows the finding; or the predictive failure analysis provides a reasonable estimated time-to-failure estimate for a component of the medical imaging device 17, or so forth).

On the other hand, if for any reason the customer C (or some other entity, such as an unauthorized user of the trained ANN 12) attempts to use the ANN 12 with an invalid cryptographic key (that is, a cryptographic key that does not match the valid cryptographic key 16), then the trained ANN 12 will output an incorrect (e.g., random or pseudorandom) result. This is due to the invalid-key training cycles 105 which trained the ANN 12 to produce incorrect (random or pseudorandom) results for invalid keys.

As previously mentioned, for medical tasks or other mission-critical tasks, the customer C is preferably instructed to verify it has the correct cryptographic key 16 before using the trained ANN 12 for any mission-critical tasks. This can be done, for example (and again in the illustrative CT image CADx analysis context), by having the customer collect a few test CT images for which the finding analysis is manually done by a domain expert such as a senior radiologist. The trained CADx ANN 12 is then applied to those test images with the key received by the customer C from the key distribution service KDS. If the received key is indeed the valid cryptographic key 16 then the CADx ANN 12 should produce correct results for the test CT images, at least to within some specified statistical accuracy of the CADx ANN 12, thus verifying that the correct key was received by the customer.

In another approach for key verification, the ANN can be constructed to provide an output that includes the clinical output (e.g., the CADx diagnosis result) and also a key validity output indicating whether the cryptographic key matches the valid cryptographic key 16. To do so, the valid-key datasets used in the valid-key training cycles 103, 104 are labeled with labels for the key validity output indicating the key is valid; while the invalid-key datasets used in the invalid-key training cycles 105 are labeled with labels for the key validity output indicating the key is invalid. In this way, the training cycles 103, 104 will train the trained ANN 12 to generate the key validity output correcting indicating whether the key used is valid.

Advantageously, the security approach disclosed herein provides the trained ANN 12 which only works with the valid cryptographic key 16. The performing of the analysis on the digital information 15 to be analyzed does not employ homomorphic encryption. This is advantageous because homomorphic encryption severely degrades the speed of the ANN 12.

In one example embodiment, the digital information 15 to be analyzed comprises a digital image, and the analysis performed at the operation 206 includes an image processing analysis. In another example embodiment, the digital information 15 to be analyzed comprises medical information of a subject, and the analysis performed at the operation 206 is a CADx analysis. These are merely illustrative examples, and should not be construed as limiting.

At an operation 208, the analysis result 32 is output. For example, the analysis result 32 can be displayed on the display device 24 of the electronic processing device 18.

### EXAMPLE

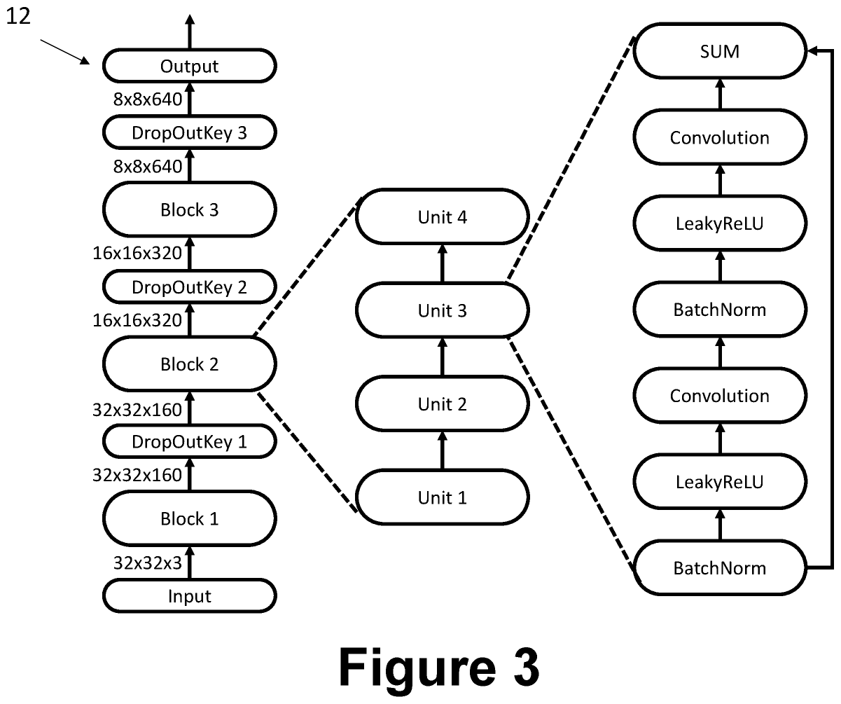

The following describes the ANN 12 in more detail. In this example, the ANN is a convolutional neural network (CNN) designed to process images, and the cryptographic key 16 has the data-structure of a mask and hence the cryptographic key 16 in these examples is also sometimes referred to as a mask. Moreover, the specific illustrative example of FIG. 3 uses three such masks as the cryptographic key 16, that are input at different stages of the CNN, and these three masks are referred to herein as DropOutKey 1, DropOutKey 2, and DropOutKey 3. A dataset which consists of fifty thousand images for training and ten thousand for testing of size 32×32×3 can be used. The CNN blocks can be interleaved with three layers of dimensions 32×32×160, 16×16×320 and 8×8×640, respectively. FIG. 3 shows an example of the ANN 12 and its layers.

The ANN 12 is trained to ensure a loss minimization using valid key masks and loss maximization using randomly generated masks. Each element of mask was generated from a Bernoulli distribution with p=0.5 and are saved for the training as correct. In an optimization process, a common cross-entropy loss (Loss=CE(logitsK,labels) was used for the first 50,000 iterations of the training cycle. Then, a special combined loss is applied according to Equation 1:

Then the combined loss previously discussed is applied:

$$Loss = \{ \begin{matrix}CE ( logitsK , labels ) , & 0 \leq ( iters mod 100 ) < 90 \\ \vert 10 - CE ( logitsR , labels ) \vert , & 90 \leq ( iters mod 100 ) < 100\end{matrix} \qquad ( 1 )$$

where CE is a cross-entropy loss, logitsK is a logits value having valid dropout masks, iters is a number of iterations passed, logitsR is a logits value having invalid dropout masks, where for each ith invalid dropout masks set the corresponding pᵢ was generated from uniform distribution from [0.3, 0.7] and each element of ith mask is randomly generated from Bernoulli distribution with p=pᵢ. A Stochastic Gradient Descent (SGD)-optimizer with weight decay and piece-wise learning rate was used. Training was performed for 300,000 iterations with batch size equal 64.

A naive implementation of such training can lead the ANN 12 to divergence. To prevent this, several techniques are used. First, the initial 50,000 iterations of the training cycles of the ANN 12 with common cross-entropy loss and correct masks. Second, a maximization of cross-entropy with randomly generated masks was performed just 10 iterations of each 100. Third, a maximum cross-entropy value was clipped to 10. Fourth, gradients were clipped from interval (−1, 1). A mean accuracy shown below in Table 1.

TABLE 1

| | Accuracy | Cross-Entropy |
|---|---|---|
| Valid cryptographic key | 66.7% | 0.932 |
| Invalid cryptographic key | 9.9% | 9.815 |

An average accuracy using invalid (i.e., simulating counterfeit) masks is equal to random guess probability. Advantageously, the distribution of activation outputs for invalid (e.g., counterfeit) masks is about the same as for the valid cryptographic mask 16, making the probability of reverse-engineering through activations negligible.

The disclosure has been described with reference to the preferred embodiments. Modifications and alterations may occur to others upon reading and understanding the preceding detailed description. It is intended that the exemplary embodiment be construed as including all such modifications and alterations insofar as they come within the scope of the appended claims or the equivalents thereof.

1. A non-transitory computer readable medium storing instructions readable and executable by at least one electronic processor to perform a method of performing an analysis on digital information to be analyzed, the method comprising:
receiving a cryptographic key;
constructing an input dataset, the input dataset including both the digital information to be analyzed and the cryptographic key;
performing the analysis on the digital information to be analyzed to generate an analysis result by applying an artificial neural network (ANN) to the input dataset; and
outputting the analysis result.

2. The non-transitory computer readable medium of claim 1, further storing the ANN, wherein the ANN is trained to:
generate a correct analysis result for the digital information to be analyzed if the cryptographic key matches a valid cryptographic key; and
generate an incorrect analysis result for the digital information to be analyzed if the cryptographic key does not match the valid cryptographic key.

3. The non-transitory computer readable medium of claim 2, wherein the method further comprises:
training the ANN on both (i) valid-key input datasets that include the valid cryptographic key and (ii) invalid-key input datasets that include randomly or pseudorandomly generated cryptographic keys;
wherein the training employs an objective function that drives the training to generate correct analysis results for the valid-key input datasets and that drives the training to generate incorrect analysis results for the invalid-key input datasets.

4. The non-transitory computer readable medium of claim 2 wherein the analysis result includes a key validity output indicating whether the cryptographic key matches the valid cryptographic key.

5. The non-transitory computer readable medium of claim 1, wherein the method of performing the analysis on the digital information to be analyzed does not employ homomorphic encryption.

6. The non-transitory computer readable medium of claim 1, wherein the digital information to be analyzed comprises a digital image and the analysis is an image processing analysis.

7. The non-transitory computer readable medium of claim 1, wherein the digital information to be analyzed comprises medical information of a subject and the analysis is a computer-aided diagnosis (CADx) analysis.

8. The non-transitory computer readable medium of claim 1, wherein the method further includes analyzing log files of a medical imaging device.

9. A method of simultaneously training and securing an artificial neural network (ANN), the method comprising:
generating a trained ANN for performing an analysis, including:
performing a plurality of valid-key training cycles on the ANN with datasets, each dataset including digital information to be analyzed and a valid cryptographic key, wherein the valid-key training cycles employ an analysis objective function that drives the valid-key training cycles to produce a correct analysis result for the digital information to be analyzed, and
performing a plurality of invalid-key training cycles on the ANN with datasets, each dataset including digital information to be analyzed and an invalid cryptographic key, wherein the invalid-key training cycles employ a security objective function that drives the invalid-key training cycles to produce an incorrect analysis result for the digital information to be analyzed; and
storing the trained ANN on a non-transitory storage medium.

10. The method of claim 9, wherein a number of the plurality of valid-key training cycles is higher than a number of the plurality of invalid-key training cycles.

11. The method of claim 10, wherein the number of the plurality of valid-key training cycles at least 5 times greater than the number of the plurality of invalid-key training cycles.

12. The method of claim 9, wherein prior to performing the valid-key training cycles and the invalid-key training cycles, a predetermined number of initial training cycles is performed with datasets in which each dataset includes the digital information to be analyzed and the valid cryptographic key and employing the analysis objective function.

13. The method of claim 9, further comprising:
generating an analysis result for input digital information to be analyzed by retrieving the trained ANN from the non-transitory storage medium and applying the trained ANN to a dataset that includes both the input digital information to be analyzed and an input cryptographic key; and
displaying the analysis result.

14. The method of claim 13, wherein the number of training cycles with the invalid cryptographic key comprises 9%-11% of the number of training cycles with the valid cryptographic key.

15. The method of claim 9, wherein the digital information to be analyzed comprise images and the analysis is an image processing analysis.

16. The method of claim 15, wherein the trained ANN has a key validity output indicating whether the input cryptographic key matches the valid cryptographic key.

17. The method of claim 9, wherein the ANN comprises a multilayer ANN.

18. The method of claim 9, wherein the ANN comprises a convolutional NN (CNN).

19. The method of claim 9, wherein the valid cryptographic key comprises one of: a binary mask, a vector, a two-dimensional array, or a three-dimensional array.

20. The method of claim 9, wherein:
the analysis objective function comprises CE(logitsK,labels) where the function CE ( . . . ) is a cross-entropy loss, logitsK are the outputs of the valid-key training cycles, and labels is a set of ground truth labels annotated to the data sets; and
the security objective function comprises |10−CE(logitsR,labels)| where the logitsR are the outputs of the invalid-key training cycles.
